(19) United States
(12) Patent Application Publication
(10) Pub. No.: US 2007/0161413 A1
(43) Pub. Date: Jul. 12, 2007

(54) Radio operated communication terminal

(75) Inventor: Jorg Schafer, Munchen (DE)

Correspondence Address: BELL, BOYD & LLOYD, LLP, P.O. BOX 1135, CHICAGO, IL, 60690, US

(73) Assignees: BENQ MOBILE GMBH & CO OHG, Munchen (DE); BENQ CORPORATION, Taoyuan (DE)

(21) Appl. No.: 10/596,661

(22) PCT Filed: Sep. 27, 2005
(86) PCT No.: PCT/EP05/54837

§ 371 Date: Jun. 20, 2006

(30) Foreign Application Priority Data
Sep. 30, 2004 (DE) 20 2004 015 231.2

(51) Int. Cl. H04M 1/00

(52) U.S. Cl. 455/575.3; 455/575.1; 455/575.4

(57) ABSTRACT

A radio operated communication terminal includes at least two housing parts which can move in relation to each other. The housing parts move by means of miniature motors. As a result, it is possible to use the constructive configuration thereof for haptic output of events.

### FIELD OF TECHNOLOGY

The present disclosure relates to a radio-operated communication terminal which comprises at least two housing parts, which can move with respect to one another.

### BACKGROUND

Communication terminals such as these are known, for example, as so-called “clamshell” appliances, in which two housing parts are connected to one another via a hinge such that they can rotate, or as so-called slider appliances, in which two housing parts can be moved with respect to one another. In this case, the housing parts of the known appliances are moved manually by the respective user.

### SUMMARY

Under an exemplary embodiment, the physical configuration of appliances is utilized for tactile outputting of events which occur in conjunction with games or signaling, where the housing parts can be moved by means of miniature motors.

Functionality is extended by preferably making use of the characteristics of mobile terminals, for example, in the “clamshell” and “slider” embodiments. This design is used for tactile outputting of events which occur in conjunction with games or for signaling.

Tactile outputting in mobile terminals increases the usefulness of the terminal.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a block diagram of an exemplary embodiment;

FIG. 2 illustrates a clamshell telephone's physical movements under the embodiment of FIG. 1; and

FIG. 3 illustrates a sliding telephone's physical movements under the embodiment of FIG. 1.

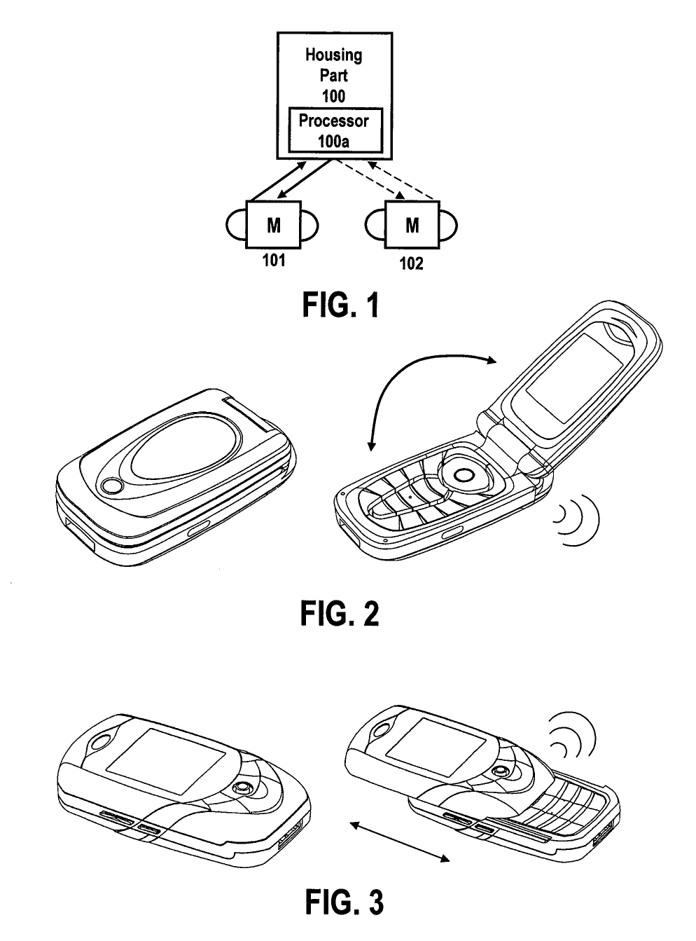

### DETAILED DESCRIPTION

Under the embodiment, miniature motors (101, 102) are driven by processor 100a in such a manner that direct force feedback is provided via the miniature motors when the manual movement of the housing parts (100) is used to make an input during a games function, as illustrated in FIG. 2.

So-called force-feedback components, for example, are preferably used for direct reaction for inputting during games.

Another refinement of the invention is characterized in that the miniature motors are driven in such a manner that incoming signaling data is output by means of a corresponding movement of one housing part.

When an incoming call arrives, a clamshell appliance, for example, can be opened automatically, as shown in FIG. 2.

Force-feedback elements have been previously used only for PC-based games, in the form of joysticks. The use of mechanical components for output purposes in mobile terminals, however, is not known.

When the appliance design is supplemented at an appropriate point by actuators (miniature motors, etc.), this increases the functional scope of the device. If the design features are already used for inputting, direct reaction in the sense of force feedback is possible.

Furthermore, the appliance can alternately be locked for specific user groups. For example, locking of the keypad of a slider appliance would prevent direct dialing, although incoming calls could still be received.

As discussed above, in FIG. 2, in the case of clamshell appliances, a capability is provided for controlled influencing of the opening angle of the appliance. As is illustrated in FIG. 3, the extension and retraction of the keypad in the case of slider appliances is also provided. Further design options such as separate control elements which can be extended or unfolded are feasible, for example, for games consoles.

In addition to the use of miniature motors in the joint of clamshell appliances or opening and closing slider appliances, other options exist, such as:

mechanical locking by the use of miniature relays,

use of actuators in games consoles, for example for unfolding additional “control wings” or for the use of the force-feedback functionality.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-3. (canceled)

4. A radio operated communication terminal, comprising:
at least two housing parts, which can move with respect to one another;
at least one miniature motor, operatively coupled between the two housing parts; and
the housing parts can be moved by means of miniature motors;
a processor operatively coupled to the at least one miniature motor, wherein the processor initiates a signal to the motor causing movement in at least one of the two housing parts.

5. The radio operated communication terminal as claimed in claim 4, wherein the miniature motors are driven such that direct force feedback is provided via the miniature motors when the manual movement of the housing parts is used to make an input during a games function.

6. The radio operated communication terminal as claimed in claim 4, wherein the miniature motors are driven such that incoming signaling data is output by means of a corresponding movement of one housing part.
